(19) United States
(12) Patent Application Publication
(10) Pub. No.: US 2024/0035510 A1
(43) Pub. Date: Feb. 1, 2024

(54) Securing Device

(71) Applicant: Kuf Verbindungselemente UG, Oelde (DE)

(72) Inventors: Uwe Prangemeier, Oelde (DE); Dorothee Prangemeier, Oelde (DE)

(21) Appl. No.: 18/482,876

(22) Filed: Oct. 7, 2023

Related U.S. Application Data
(63) Continuation-in-part of application No. PCT/EP2022/059461, filed on Apr. 8, 2022.

(30) Foreign Application Priority Data
Apr. 10, 2021 (DE) 10 2021 108 948.4
Mar. 7, 2022 (DE) 10 2022 105 253.2

(51) Int. Cl. F16B 39/282; F16B 39/24

(52) U.S. Cl. CPC F16B 39/282; F16B 39/24

(57) ABSTRACT

A securing device (1) for establishing a secured screwed connection (2), comprises at least one securing component (1a) that is configured as one of a washer (3), a threaded nut (3a), a threaded screw (3b), and/or a securing unit (3c). The securing component (1a) comprises a contact body (2a) with two opposite outside surfaces (2b, 2c), at least one of which is configured as a contact side (4, 5) for contacting a counter layer (23, 24). The contact side (4, 5) of the contact body (2a) is broken by sharp-edged depressions (7). The surface ratio (40a) of the contact surface of the contact side (12) to the side surface (40) is larger than the surface ratio (40b) of the depressions (7) to the side surface (40).

### REFERENCE TO RELATED APPLICATIONS

This non-provisional utility patent application is a continuation-in-part (by-pass) of application PCT/EP2022/059461 filed on 8 Apr. 2022 designating the United States of America and published on 13 Oct. 2022 as WO 2022/214667 A1. Application PCT/EP2022/059461 claims the priority of two German patent applications, namely DE 10 2021 108 948.4 filed on 10 Apr. 2021 and DE 10 2022 105 253.2 filed on 7 Mar. 2022.

### BACKGROUND OF THE INVENTION

The present invention relates to a securing device for establishing a secured connection and in particular a secured screwed connection. The securing device comprises at least one securing component, which is in particular configured as a washer, a threaded nut, a threaded screw, and/or a securing unit. Moreover the invention also relates to a method of manufacturing such a securing device.

Securing devices are intended to secure screwed connections permanently against loss of prestressing force and unintentional loosening. The prior art has disclosed a variety of securing devices for establishing secured screwed connections.

Primarily, washers having planar and smooth supporting surfaces have been disclosed. Friction generates a force-fit connection between counter layers, such as a component and a screw with a screw head, or a nut. The washer allows distribution of the prestressing force applied by a screw head or a nut, over a large surface, so as to enable higher prestressing forces, while not damaging the counter layer. The drawback thereof is that already the smallest loads, such as continuous vibrations, can cause the counter layers to drift relative to the washer. Such relative motion causes the screw or the nut to loosen. This is why a simple washer with planar contact surfaces can secure a screwed connection only inadequately.

The so-called LOCKTIX® disks have disclosed flat washers comprising elevations protruding outwardly pyramid-like, distributed over their entire side surface. The functionality is per se satisfactory. However, the pyramid-like elevations can make impressions in the surface of the counter layer over the operational lifetime. With progressive settling and creeping, the prestress of the screwed connection can considerably decrease. Also, the surface or for example a varnish coat may be damaged. Therefore, improved screw lock devices are desirable.

Basically, e.g., a screw head can loosen as the screwed connection loses its prestressing force. It is therefore significant to prevent rotation of the screw head or the screw in the fastened state. To prevent relative motions, e.g. DE 20 2020 101 633 U or DE 30 42 388 A1 have disclosed spring washers for securing screwed connections.

A spring washer disclosed in DE 30 42 388 A1 shows a disk-shaped body with trapezoidal, pointed elevations protruding outwardly, on which scraping edges are formed. The scraping edges dig into the workpiece surface namely the counter layer during and after screw-fastening. This causes the spring washer to be wedged. A drawback is that the surface of the counter layer may be damaged. Moreover, it has been found that after tightening, the prestress may considerably decrease due to settling and creeping. This reduces the securing, and moreover the surfaces may be damaged.

DE 20 2020 101 633 U1 has disclosed a lock washer with an annular disk body. The spring force is provided to be such that the spring effect can even out the loss of prestressing force caused by settling and/or creeping. The disk body shows knurling in the shape of an engaging or toothing structure protruding obliquely outwardly with a serrated surface. The disk body is convex in cross section. For screw-fastening, the ring is deformed and clamped between the counter layers. The serrated surface is wedged in the counter layer, and in this way it is intended to prevent a screw head from loosening. It is again a drawback that the surface of the counter layer can be damaged by the points protruding outwardly, and as settling and creeping progresses, the prestress can considerably decrease. Moreover, the relative motion may end in the points destroying the finish or surface coating of a component.

Moreover, disk-shaped securing devices have been disclosed, showing planar contact surfaces with pointed elevations, such as they are known from DE 299 22 315 U1 or GB 93688 A. During tightening, the elevations dig into the surfaces of the counter layers, thus securing the screwed connection. Basically, during tightening the retaining washers first allow good, form-closed force transmission. High prestressing forces may result in the elevations impressing further over time. Thus, the prestressing force of the screwed connection decreases. In the case of additional, alternating loads, such as vibrations, the screwed connection may then particularly readily loosen.

Moreover, securing devices with wedge lock washers have been disclosed, such as in CN 209278312 U or EP 3 253 977 A1. Two matching lock washers are positioned between a screw head and a component. On the sides facing the screw head and the component, radially outwardly extending ribs are formed, which may dig into the screw head or the component in a form-fit. The sides of the wedge lock washers facing one another show stepped wedges, engaging with one another. The wedges show a gradient larger than that of the screw of a screwed connection intended to be secured, so as to provide high resistance to loosening of the screwed connection. During tightening, the disks can deform relative to one another. In general, there is provided high resistance to loss of the prestressing force and also to the screwed connection loosening. The drawback is that pairs of disks cannot be employed universally but must be specifically adapted to a screwed connection. Moreover, the two-piece wedge lock washers must be manufactured to fit together. On the whole, wedge lock washers are complicated to manufacture. This is why wedge lock washers are very expensive and tend to be used in very specific cases only. Another drawback is that the ribs dig into the surfaces of the counter layers, damaging these, and thus also decreasing the prestressing force.

### SUMMARY AND OBJECTS OF THE INVENTION

Therefore, it is the object of the present invention to provide a securing device for screwed connections which is independent of the thread geometry, which ensures, with simple means, an improved safeguard against loss of the prestressing force and loosening of the screwed connection, and, in particular, largely prevents damage to the surface of a counter layer. The securing device is in particular intended for less expensive manufacturing than equivalent securing devices existing in the prior art.

The object is solved by a securing device for establishing a secured screwed connection, comprising at least one securing component in the form of a washer, wherein the securing component comprises a contact body with two opposite outside surfaces, at least one of which is configured as a contact side for contacting a counter layer and comprising a side surface on the contact side, wherein the securing component comprises at least one through opening connecting the two outside surfaces to pass through a threaded pin, wherein on the contact side of the contact body, a planar contact surface is configured that is broken by a plurality of sharp-edged depressions and defines a contact level, limiting the contact body in the region of the side surface, so that the contact body does not protrude beyond the contact level in the region of the side surface, wherein the surface ratio of the planar contact surface disposed on the contact level to the side surface is larger than the surface ratio of the sharp-edged depressions to the side surface. Securing devices may also have securing component in the form of a threaded nut, threaded screw, or a securing unit. Further advantages and features of the present invention can be taken from the general description and the description of the exemplary embodiments.

A securing device according to the invention serves to establish at least one connection secured in particular permanently, and in particular a secured screwed connection. The securing device comprises at least one securing component, the securing component comprising, or being configured as, e.g. a washer, a threaded nut, a threaded screw, and/or a securing unit. The securing component comprises at least one contact body with at least two outside surfaces opposite one another, at least one of which is configured as a contact side (configured substantially as a planar) for contacting a counter layer. The securing component and in particular the contact body includes a side surface on the contact side. The securing component comprises at least one through opening connecting the two outside surfaces to pass through, and in particular to receive, e.g. a threaded pin and/or at least one threaded pin protruding from the contact side of the securing component (adjacent to the side surface). On the contact side of the contact body, a planar contact surface defining a contact level is configured that is broken by a plurality of (in particular sharp-edged) depressions. The contact level delimits the contact body in the region of the side surface. In the region of the side surface, the contact body does not protrude beyond (the contact level). The surface ratio of the contact surface disposed on the contact level on the side surface to the side surface is preferably larger than the surface ratio of the (sharp-edged) depressions to the side surface.

The invention has many advantages. A substantial advantage of the invention is that the contact surface is configured on a shared contact level. This provides a very large, planar surface ratio of the side surface, which allows a particularly large-area support. At the same time, depressions are configured to a lesser extent on the side surface, breaking the planar contact surface. When tightening a screwed connection using sufficient tensioning force, the screw shaft is elastically prestressed.

The effects of settling are minimized by way of the large contact surface. According to the invention, negative effects of creeping are likewise minimized by the large surface ratio of the planar contact surface. Moreover, the effects of creeping are utilized advantageously since a certain elastic deformation of the surface of the counter layer results, and some material of the counter layer deforms elastically and creeps into the depressions. Thus, a kind of elastic form-fit is obtained which is released as the connection, and thus the prestress, is released. The predominant surface ratio of the planar contact surface disposed on one shared contact level thus effects prevention of damage to the surface of the counter layer. A screwed connection can be reliably secured and damages can be prevented. The invention allows improved function with simple and inexpensive means. What is significant therefor is the high ratio of a planar contact surface and a (considerably) small ratio of depressions in-between, while showing no projections or points protruding above the contact surface. Also possible is a certain measure of plastic deformation on the counter layer.

The contact surface(s) of the contact side define a contact level. The contact surface or surfaces in particular all extend entirely on the contact level and are moreover limited by way of the contact level, not protruding beyond the contact surface. The contact side comprises in particular (only) planar contact surface(s) and depressions configured on the contact side.

The side surface is particularly preferably composed of the contact surface and the surface of the depressions. In the absence of depressions (as in the known flat washers), the side surface would represent the total surface. In this case, the side surface is particularly preferably the theoretical (planar) total surface.

Preferably, the surface ratio of the (planar) contact surface relative to the side surface is larger than 60% or larger than ⅔ or larger than 70% or larger than ¾.

In particular is the surface ratio of the depressions relative to the side surface larger than 5% or larger than 8% or larger than 10%. The surface ratio of the depressions to the side surface may reach 20%, 25% or 30%, or as much as ⅓ or more than 40%.

Particularly preferably the surface ratio of the surface of the depressions relative to the side surface is smaller than 40% or 35% or smaller than 30% or smaller than 25% or smaller than 15%.

In a simple configuration, the surface ratio of the contact surface to the side surface may be approximately 70%, and the surface ratio of the surface of the depressions to the side surface, approximately 30% (each about ±5%).

In advantageous specific embodiments, a number of separate, individual depressions are configured on the contact surface. The depressions may be entirely separate from one another or may be interconnected in parts or in sections.

Preferably, a plurality of contact regions, each having planar contact surfaces and (recessed) depressions disposed in-between, is configured on the contact side of the contact body. The contact surfaces of the contact regions (collectively) form the contact level. It is also conceivable for nearly all of a plurality of surface areas to be disposed on one shared contact level, while one surface area or individual surface areas are recessed and disposed outside of the shared contact level. Then, such a surface area counts as a depression.

Outside of the side surface and the contact area with a counter layer, some protruding sections may be provided, which, however, do not contribute to security.

In preferred configurations the contact level limits the contact body overall, so that the contact body does not protrude beyond (transverse to the contact level).

Advantageously, the contact surfaces are disposed perpendicular to their surface at offsets of a maximum of 50 μm or 30 μm, or less than 10 μm.

Advantageously, the contact surfaces or at least 80% of the contact surfaces of the contact regions (or the contact surface overall) comply with a shared planeness according to DIN EN ISO 1101-2017.

A “depression” in the sense of the present invention is preferably always understood to mean a sharp-edged depression. Thus, the term “depression” in this application can continuously be replaced by the term “sharp-edged depression.”

Preferably, one (and in particular a predominant number of, or nearly every or every) transition from (the contact regions with) the planar contact surface to a wall of the depression is angular. The transition is preferably configured sharp-edged according to DIN EN 13715-2020-01.

Particularly preferably, the transition is configured with a transition radius smaller than 50 μm or smaller than 30 μm and in particular smaller than 20 μm or as small as 10 μm or even smaller than 10 μm.

Preferably, the transition is configured with a transition radius smaller than ⅕ or 1/10 the width of the depression. Given a depression of a width of 300 μm, the transition radius from the wall of the depression to the contact surface is preferably less than 30 μm.

In advantageous configurations, a transition radius is smaller than one half percent or smaller than 1/10 or 1/20 percent of the external diameter of the contact body.

Preferably, the angle between faces of (the contact region with) the planar contact surface to a wall of the depression is between 45° and 95°. Steeper angles are preferred. In particular, the angle between faces of the depression to the contact region is between 85° and 95° or is (approximately) perpendicular.

In advantageous specific embodiments, the relationship of the width of a depression to the depth of the depression is between 3:1 and 1:3. The width is the shorter transverse extension, and the length is the larger transverse extension of the depression. In circular depressions, the width and length are (nearly) identical.

The relationship of the width to the depth pf the depression is in particular between 2:1 and 1:2.

The depth of the depression may in particular depend on the purpose provided. The choice of material of the contact body and the counter layer may be influential as well. Preferably, the bottom of the depression may show a (maximum) depth of up to 1 mm or as much as up to 5 mm, from the contact level. Considerably shallower depths of 100 μm or 150 μm or 250 μm are likewise preferred.

In all the configurations the depression may show a rounded bottom.

The depressions show in particular, at least in sections, a sharp-edged boundary (in the transition from the depression to the contact surface), with the boundary not protruding beyond the contact level and the contact surface(s) being configured as a planar. A boundary in the sense of the present application is particularly preferably the transition from the planar contact surface to a depression.

A considerable advantage of the invention is that a counter layer, comprising a screw part such as a screw with a screw head or a nut, or a component, can settle in the depressions having angular edges or a sharp-edged boundary when tightening e.g. a screwed connection. Advantageously, the counter layer is elastically deformed during tightening, so as to engage at least partially in the depression. A form-closed connection is in particular established. The counter layers may preferably be supported on the contact surface up to the sharp-edged boundary. Moreover, creeping (time-dependent plasticization by exceeding the liquid limit) due to high prestressing forces results in the counter layer to settle still further in the depression, so that a (minor) lengthening of a screw pin and thus a (minor) loss of the prestressing force do not show any adverse effects. The large-area contact surface allows to achieve a high degree of support. Advantageously, this principle is particularly effective with high prestressing forces. Particularly advantageously, the function of the securing device is in particular independent of the thread geometry of a screw or a pin.

Ultimately, in a screwed connection secured by the securing device, the loss of prestressing force is very small, in particular including with dynamic loads over extended time periods. Thus, a Junker test of the securing device has shown that loss of the prestressing force in a screwed connection secured by the securing device according to the invention shows as noticeably less than 15% (relative to the initial value). According to ISO 16130 this corresponds to an excellent securing function. In the test this result could not be achieved by the other securing devices known in the prior art.

Moreover, optimizing the torque advantageously also allows to show reduced loss of prestressing force in a Junker test. In particular is form closure increased and is retained permanently.

Preferably, a permanently secured, form-closed connection is generated. This will effectively prevent the screwed connection from loosening unaided. Moreover, the form closure of the counter layers in the depressions allows a loosening moment or torque for undoing the screwed connection to be larger than a tightening moment with which to tighten the screwed connection.

The depressions can be manufactured inexpensively, in particular by reshaping. Advantageously, a securing device is thus provided having an excellent securing function, which can advantageously be manufactured at lower cost than the securing devices known from the prior art, while showing a similar, and presently even improved, securing function.

A through opening in the contact body is in particular entirely closed and preferably configured as a through hole. Moreover, a contact body with a through opening may be configured slotted or strap-like or (in a top view) U- or V- or W- or C-shaped, so that in these configurations the through opening is not circumferentially closed.

In an embodiment including a pin and in particular threaded pin protruding from the securing component, the securing component may be configured as a threaded screw with a screw head. Then the contact side of the threaded screw is in particular configured on a front face of the screw head facing and surrounding the threaded pin. A contact side (the front face) of the screw head has a side surface provided for contacting the counter layer. The threaded pin in particular shows a thread, at least in sections.

Advantageously, a threaded pin configured on the contact body is provided for passing through the through opening of a securing component configured as a washer or a threaded nut or a securing unit. Advantageously, a threaded screw shows at least a screwable thread. A screwable thread is in particular configured on the threaded pin.

A screwable thread may in particular be configured in the through opening. Preferably, the washer and/or the threaded nut comprise at least two contact sides (and in particular exactly two contact sides), namely, at least one top contact side and one bottom contact side. The two contact sides are in particular aligned approximately in parallel (or exactly parallel) to one another. Also possible is an oblique or angled alignment of the opposite outside surfaces and in particular the two contact sides.

The securing unit may for example be configured as, or at least comprise, a component securing a screwed connection.

At least one depression is provided on the contact side. The contact side shows in particular a plurality of for example 5, 10, or 20 depressions. Advantageously, a contact side may comprise circa 40 or 60 or still more depressions. Moreover, at least one contact side may show noticeably more depressions. Preferably, the contact side may show a plurality of depressions. While the depressions may include a bottom, they may be configured (partially or entirely) as through holes. The depressions may be made by embossing or, e.g., mill cutting. Through holes may be made by mill-cutting, boring, punching, by Laser, or by water jet or the like.

The boundary of the depression in the sense of the present application describes in particular the transition between the depression and a planar contact surface extending along the pertaining contact side. The planar contact side in particular comprises a (shared) planar contact surface. Preferably, the depressions are configured on the planar contact surface of the contact side, breaking the shared contact surface.

The sharp-edged boundary at the depression of the washer preferably shows a tolerance of the workpiece edges of at least circa±0.1 mm. The boundary of the washer in particular shows a tolerance of the workpiece edges of circa±0.01 mm (±30%). Moreover, the tolerance of the workpiece edges may be smaller still. Preferably, the boundary is configured nearly ideally sharp-edged. Advantageously, the sharp-edged boundary allows local deformation of the counter layer when tightening the screwed connection, so that it will settle in the depression. Sharp-edged is understood to mean angled in a geometric sense.

Advantageously, the angle between faces of the depression to the contact side at the boundary is between 75° and 105°. The angle between faces is in particular larger than 85° and smaller than 95°. Particularly preferably, the angle between faces shows a value of circa 90° (±3°). The angle between faces which is, in particular, a right angle, preferably allows the sharp-edged boundary to absorb a loosening force acting tangentially toward the contact sides in its entirety. Advantageously, the screwed connection is thus prevented from loosening. Lifting is in particular prevented, which would break the form-closed connection. Preferably, the angle between faces is configured substantially constant along the entirety of the boundary of the depression, to ensure the function.

Particularly preferably, at least the boundary of the depression is configured with a fixing edge (in particular linear) at least in sections. Preferably, the fixing edge is configured linear in cross section. The linear fixing edge in particular has a depth to the contact side of up to 0.05 mm or more, before a rounding or the like shows.

Advantageously, the fixing edge allows an even contact of the counter layer against the boundary of the depression. The fixing edge allows distribution of an acting force over a surface. Preferably, this relieves the load on the sharp-edged boundary. Larger depths of the fixing edge are likewise possible. Advantageously, the depth of the fixing edge is matched to an (axial) stretching of the screwed connection when tightening, respectively to the stretchability of the screwed connection. The angle between faces is in particular constant along the fixing edge. Advantageously, the fixing edge is configured along the entire boundary to ensure a securing function independent of directions. Preferably, the depression (in its entirety) shows a noticeably larger depth than does the fixing edge. To this end, the depression may be configured in cross section, at least in sections, for example circular, elliptic, polygonal, and/or rectangular. The depression may extend from the surface at right angles. Alternately it is possible for the depression to show a semicircular cross section, so that only the immediate boundary shows on the surface an angle of in particular 90° to the surface of the contact side. In the bottom region, the bottom may be rounded.

The penetration depth of the counter layer is advantageously shallower than is the depth of the fixing edge. The shallow penetration depth is in particular noticeably less than one millimeter (depending on the material), so as to prevent damage to the counter layer. A varnish coat or a corrosion coating remain intact. For small screwed connections, the penetration depth of the counter layer may be for example up to approximately 0.05 mm.

Preferably, a portion of the contact surface is at least 50% of the (entire) surface (side surface) of the contact side. Advantageously, a portion of the contact surface of the contact side is at least 60% of the surface of the contact side. Preferably, a portion of the contact surface of the contact side is at least ⅔ or 70% or 75% or more. Preferably, a portion of the contact surface may be up to 95% or still more. A sharp-edged boundary does not protrude beyond the planar contact surface. The large contact surface in particular ensures planar contact and establishing a force-fit connection.

In all the configurations, the depressions are in particular disposed distributed over the side surface (or a substantial portion or predominant portion of the side surface) of the contact side.

Preferably, the depressions are configured as in particular elongated grooves or notches. All the features described below apply in analogy to notches as well. Preferably, the grooves are distributed over a substantial portion of the side surface. Advantageously, grooves can be manufactured inexpensively by reshaping. An elongated groove in particular has a length noticeably larger than the width and/or depth of the groove. Moreover, a groove preferably has a straight edge on which a counter layer can (settle and) be supported in a form-fit. Moreover, the depression may be for example circular, triangular, or rectangular in configuration.

Preferably, the groove may extend straight or in a ring shape. The straight groove may, at least in sections, extend transverse and/or radially along the planar contact side.

Advantageously, a groove shows a width between one thousandth and one tenth of the diameter of the contact side. A groove for small screwed connections in particular has a width between circa 0.01 mm and circa 1 mm. A groove in particular has a width of circa 0.05 mm to 0.50 mm (±100%). Moreover, wide grooves are likewise possible. A wide groove presents lower resistance to deformation for the counter layer.

Advantageously, a groove has a depth between one fiftieth and one tenth of the diameter of the contact side. A groove for small screwed connections can in particular have a depth to the contact side between circa 0.1 mm and 1 mm. Preferably, a groove has a depth of circa 0.1 mm (±50%). Moreover, greater depths are possible as well. The minimum depth of a groove is, in particular, determined by the depth of the fixing edge.

Preferably, the grooves extend at least in pairs angled to one another and respectively intersecting. Preferably, the grooves show at least one or multiple intersections. Preferably, the depressions and in particular the grooves form at least one netlike structure. Advantageously, this allows blocking (taking into account the prestressing force) at least in part or even (nearly) entirely, any movement, respectively migration, of the counter layers accommodated in a form-fit in all the axes of rotation. Thus, the positions of the counter layers are in particular fixed in a form-fit. Preferably, this prevents reduction of the self-retention of the screwed connection. Preferably, loss of the prestressing force and loosening of the screwed connection are thus prevented. Preferably, netlike structures on the top contact side may differ relative to the bottom contact side.

In particular, at least one intersection angle of an intersection shows a value between at least 30° and 150°. Preferably, an intersection angle shows a value between 60° and 120°. An intersection angle in particular shows a value of ca. 90° (±30%). Advantageously, an intersection angle of ca. 90° supports the acting forces by means of the sharp-edged boundaries evenly in all the directions.

Preferably, a netlike structure is formed by a plurality of grooves, which intersect at least in pairs. Advantageously, the netlike structure extends at least over a substantial part of the contact side. The netlike structure is in particular at least partially configured honeycombed. The netlike structure in particular extends over the entire contact side. Advantageously, the netlike structure with the plurality of grooves and sharp-edged boundaries (profile edges) allows to completely prevent the counter layers from migrating.

Advantageously, the contact body and in particular the securing component, and in particular at least the washer and/or preferably the threaded nut and/or the securing unit, is/are configured mirror-symmetrical at least in sections. Preferably, the contact body and in particular the securing component, and in particular at least the washer and/or preferably the threaded nut, is/are configured rotationally symmetrical, at least in sections. This enables in particular easy mounting. Preferably, at least the depressions on one of the top and one bottom contact side(s) are configured mirror-symmetrical. This preferably enables low-cost manufacture and mounting.

Advantageously, the washer shows the dimensions of a suitable standard washer according to the suitable DIN standard, in particular according to DIN 125, or ISO standard. Preferably, at least one washer diameter corresponds to the standard washer diameter. Preferably, at least the height of the washer corresponds to the height of a standard washer. Preferably, at least the diameter of the through opening corresponds to the diameter of the standard washer. In particular, at least the tolerances of the washer correspond to those of the standard washer. Advantageously, the securing device provides low-cost exchanges of the washers if screwed connections are provided. The function of a screwed connection with the washer according to the invention does not require verification by way of complex tests after exchanging. Provided lengths of thread engagement and geometric dimensions are preferably retained.

Advantageously, at least the depressions are manufactured by at least one embossing step. Preferably, the embossing step (of the depressions and in particular the grooves) allows to manufacture a sharp-edged boundary. The depressions are in particular manufactured on one contact side or two or more contact sides by embossing.

Preferably, at least the washer may be manufactured by using a standard washer, into which depressions with sharp-edged boundaries are made by way of reshaping and embossing.

Preferably, the contact body of the securing device is at least partially manufactured of stainless steel (non-rusting steel). Stainless steel is in particular considered therefor. Then, the securing device is advantageously maintenance-free and wear-free.

Moreover, simple steels are possible although they may be prone to corrosion. Then, the securing component preferably comprises at least one corrosion coating. Advantageously, the corrosion coating may comprise for example zinc, zinc lamella and/or nickel. Preferably, this ensures a long service life and also safe function of the securing device.

Depending on the application, at least the contact body or the securing component may be manufactured of brass, plastic or wood or the like.

Preferably, at least the contact side of the contact body shows a surface hardness or through hardening which is 50 HV or above 150 HV (Vickers hardness). Advantageously, the contact side shows a surface hardness or through hardening which exceeds 250 HV or even 350 HV. In particular, the hardness or surface hardness may show a value of 500 HV or more. Moreover, a still higher (surface) hardness is likewise possible.

Preferably, at least the surface hardness of the contact side is higher than the surface hardness of a counter layer. Advantageously, this ensures settling of the counter layers in the depressions, and form-fit connection. The counter layer shows a lower surface hardness, preferably deforming during tightening. Thus, the counter layer can in particular settle in the sharp-edged depression. A deformation of the depression, or only of the sharp-edged boundary of the depression, is preferably prevented. The hardening depth has in particular at least the same depth as does the fixing edge, so as to allow ensuring safe function of the securing device. Preferably, any existing contact sides show the same surface hardness.

In preferred configurations, the securing device comprises an object on which a counter layer is configured, wherein the contact body rests with its contact side against the counter layer of the object, and a fastener and in particular screwing means urges it against the counter layer of the object.

Advantageously, the securing device comprises at least one washer and/or a threaded nut and/or a threaded screw having a contact body. The securing device comprises in particular at least one further screw part. A screw part may in particular also be configured as a threaded pin.

Preferably, the securing device comprises at least one component respectively is at least partially matched to a component. Preferably, at least one thread and/or at least one bore or screw sleeve may be configured and/or disposed on the component for establishing the screwed connection. Preferably, the screwable part and/or the component show a lower surface hardness than does the washer, so that settling the counter layers in the depressions combined with a securing function can be matched to one another. Advantageously, the materials of the counter layers may be matched in dependency on the material and the surface hardness of the counter layer.

The securing component, and in particular the washer, in particular rest on the component over the entire diameter. Preferably, establishing a form-fit connection is thus ensured. Preferably, the screwable part rests over a diameter smaller than the diameter of the washer. This ensures that friction between the surface of the component and the washer will always be larger than friction between the screw head or a nut and the securing component. Consequently, the screw head or the nut preferably slip through relative to the securing component. In particular, no relative motion is generated between the securing component and for example a component, so as to prevent damage to the component surface. Thus, varnish coating and other delicate surfaces can be effectively protected against damage or local destruction.

In preferred specific embodiments of all the configurations the securing device is configured as, or comprises, a lug nut. A washer may be configured or received on the lug nut, comprising a contact body which rotatably receives a washer. The contact body is provided with a contact side, broken by a plurality of depressions. The contact side is configured with a planar contact surface, broken by depressions and defining a contact level limiting the contact body in the range of the side surface.

In a preferred, simple configuration, a securing device according to the invention is provided for establishing a secured connection and in particular a secured screwed connection, comprising, or configured as, at least one securing component. The securing component comprises, or is configured as, a washer or a threaded nut. The securing component comprises a contact body with two opposite outside surfaces, wherein at least one of which (or both) is/are configured as a contact side for contacting a counter layer and comprising a side surface on the contact side. On the contact body, a through opening connecting the two outside surfaces is configured to pass through e.g. a threaded pin. The through opening may be configured circumferentially closed, as a through hole. Alternately, the contact body may surround, or be configured to surround, the through opening e.g. in a C-, U-, V-, or W-shape. On the contact side of the contact body, a planar contact surface is configured that is broken by a plurality of depressions and defines a contact level, limiting the contact body in the region of the side surface, so that the contact body does not protrude beyond in the region of the side surface, wherein the surface ratio of the contact surface disposed (configured) on the contact level to the side surface is larger than the surface ratio of the depressions to the side surface.

In a particularly simple configuration of this variant, the securing component is a washer, on the side surface of which a plurality of depressions breaks a shared contact level, wherein the surface ratio of the depressions is (considerably) smaller than the surface ratio of the contact surfaces on the contact level.

In another preferred, simple configuration, a securing device according to the invention is likewise provided for establishing a secured connection and in particular a secured screwed connection, comprising, or configured as, at least one securing component. The securing component comprises, or is configured as, a threaded screw or a securing unit. The securing component includes a contact body with two opposite outside surfaces, at least one of which is configured as a contact side for contacting a counter layer and comprising a side surface on the contact side. The securing component includes at least one pin and in particular threaded pin protruding from the contact side of the securing component. The pin or threaded pin is disposed adjacent to the side surface on the contact body and may be indirectly or immediately adjacent thereto. On the contact side of the contact body, a planar contact surface is configured that is broken by a plurality of depressions and defines a contact level, limiting the contact body in the region of the side surface, so that the contact body does not protrude beyond (beyond the contact level) in the region of the side surface. The surface ratio of the contact surface disposed on the contact level is larger on the side surface than the surface ratio of the depressions on the side surface.

In a particularly simple configuration of this variant, the securing component is a threaded screw having a screw head and a pin, wherein a contact side for contacting a counter layer is configured on the bottom face of the screw head. The contact side shows a side surface with contact surfaces on one shared contact level, broken by a plurality of depressions. The surface ratio of the depressions is (considerably) smaller than the surface ratio of the contact surfaces on the contact level.

In preferred configurations, a plurality of depressions is configured as through holes in a securing device.

Preferably, the axis of symmetry of a through hole extends transverse to a side surface and/or a contact level.

At least one through hole shows a cross section taken from a group of cross sections comprising round and oval and rounded, and rounded, angular cross sections.

A through hole in particular has a maximum diameter of less than 1 mm.

Preferably, the maximum diameter of a through hole is less than 1/20 or 1/30 or 1/40 of the maximum external diameter of the contact body.

Preferably, the distance between two adjacent through holes is at least twice that of the maximum diameter of a through hole.

In all the configurations it is preferred for the contact body to consist at least predominantly of a ceramic material.

Preferably, the contact body comprises the material zirconium oxide ceramics. The contact body in particular consists at least considerably, and in particular predominantly, or entirely, of zirconium oxide ceramics. The material used is particularly preferably ZrO2J (Zirconium Oxide J). The material used is in particular ZrO2+Y-PSZ (“yttria-partially stabilized zirconia <Y-PSZ>”). The material is particularly hard and very suitable for high-quality applications.

According to the invention, what is claimed is also, using a modular unit for establishing a secured connection and in particular a secured screwed connection, the modular unit comprising a contact body with two opposite outside surfaces, at least one of which being configured as a contact side for contacting a counter layer and showing a side surface on the contact side. The modular unit comprises at least one through opening connecting the two outside surfaces to pass through e.g. a pin and in particular threaded pin, and/or at least one pin respectively threaded pin protruding from the contact side of the modular unit (adjacent to the side surface on the contact body). On the contact side of the contact body, a planar contact surface is configured that is broken by a plurality of depressions and defines a contact level, limiting the contact body in the region of the side surface (=over the entire side surface), so that the contact body does not protrude beyond (beyond the contact level) in the region of the side surface. The surface ratio of the contact surface disposed on the contact level is larger on the side surface than the surface ratio of the depressions on the side surface. Particularly preferably, the modular unit used is a securing component as described above.

An alternative securing device according to the invention serves to establish at least one, in particular permanent, secured connection and in particular a secured screwed connection. The securing device comprises at least one securing component, the securing component comprising, or being configured as, e.g. a washer, a threaded nut, a threaded screw, and/or a securing unit. The securing component comprises at least one contact body with at least two outside surfaces opposite one another, at least one of which is configured as a contact side (configured substantially as a planar) for contacting a counter layer. The securing component and in particular the contact body includes a side surface on the contact side. The securing component comprises at least one through opening connecting the two outside surfaces to pass through, and in particular to receive, e.g. a threaded pin and/or at least one threaded pin protruding from the contact side of the securing component (adjacent to the side surface). On the contact side of the contact body, a planar contact surface is configured that is broken by a plurality of elevations and defines a contact level. The contact level delimits the contact body in the region of the side surface. In the region of the side surface, the contact body does not protrude beyond (the contact level), except for the elevations. Particularly preferably, the surface ratio of the contact surface disposed on the contact level is larger on the side surface than the surface ratio of the elevations on the side surface.

Here, the functional principle is reversed. Basically, what was a depression is now an elevation. The surface ratio of the elevations is preferably small and is preferably less than ⅓ of the side surface. Then the elevations penetrate into the counter layer, and the planar contact surface will absorb and discharge the forces. The elevations showing in particular an angular edge structure may establish a form-fit connection with the counter layer. Optionally, the deformation of the counter layer in the region of the elevations is elastic, so that the counter layer will not be damaged. Such a configuration is in particular suitable for backing components, threaded nuts and washers, or lug nuts with a rotatably accommodated washer.

The presently disclosed method may serve to manufacture a securing device according to the invention. The depressions are manufactured by at least one embossing step at least to the contact side(s) of the contact body. Advantageously, the embossing step allows to achieve, applying very high pressure, a very precise mapping of a shape such as an embossing punch. Preferably, an embossing step may ensure manufacture of sharp-edged boundaries which, in particular, show angles between faces of circa 90° (±10°). Moreover, manufacturing the depressions is also conceivable by means of a chip removing production process.

Preferably, a standard washer or an existing standard washer is used to manufacture the depressions on the washer. Standard washers, in particular according to DIN 125, are advantageously readily available while also being inexpensive. Moreover, special disks can be used showing in particular non-standard dimensions.

Preferably, the depressions (on both contact sides) are manufactured by exactly one embossing step (on both sides). Preferably, the contact side of the contact body of the securing component can be manufactured by one embossing step. Advantageously, the washer of the securing device can thus be manufactured in one single process step. This renders manufacture particularly cost-effective. Moreover, the depressions may also be manufactured by multiple process steps and in particular by multiple embossing steps.

Advantageously, the embossing step also achieves crushing and compression of the contact body. The high embossing force allows to achieve high geometrical accuracy. Moreover, the contact body is crushed in the direction of loads, so as to compact the inner structure of the contact body so that a screwed connection is not significantly changed in particular under the load.

In particular, at least one contact side of the contact body is at least surface-hardened or through-hardened after the embossing step. Preferably, the entire contact body is surface-hardened. In particular at least one contact side of the contact body is coated with a corrosion coating after hardening to protect from corrosion. Preferably, the entire contact body is provided with a corrosion coating. Advantageously, this ensures securing of function and a long service life of the securing device.

### BRIEF DESCRIPTION OF THE DRAWINGS

Further advantageous specific embodiments and features of the present invention can be taken from the exemplary embodiments that will be discussed below with reference to the enclosed figures. The figures are:

FIGS. 1a-1e: schematic views of securing devices according to the invention; in particular FIG. 1b is a partial cross-section of the securing device shown in FIG. 1a and FIG. 1e is a partial cross-section of the securing device of FIG. 1d;

FIG. 2: a schematic, perspective view of another exemplary embodiment of a securing device according to the invention;

FIGS. 3a and 3b: schematic side views of two embodiments of a screwed connection secured by means of a securing device according to the invention;

FIG. 4: a schematic detail view of a portion A of the securing devices shown in FIGS. 3a and 3b showing a depression with a counter layer settled in a form fit of a securing device according to the invention;

FIG. 5: a schematic detail view of various cross sections of depressions of a securing device according to the invention;

FIGS. 6a and 6b: schematic sectional views of two embodiments of a screwed connection secured by means of securing devices according to the invention; and

FIG. 7: a schematic side view of a securing component configured as a securing unit with a through hole and a threaded pin of a securing device according to the invention.

### DETAILED DESCRIPTION OF THE INVENTION

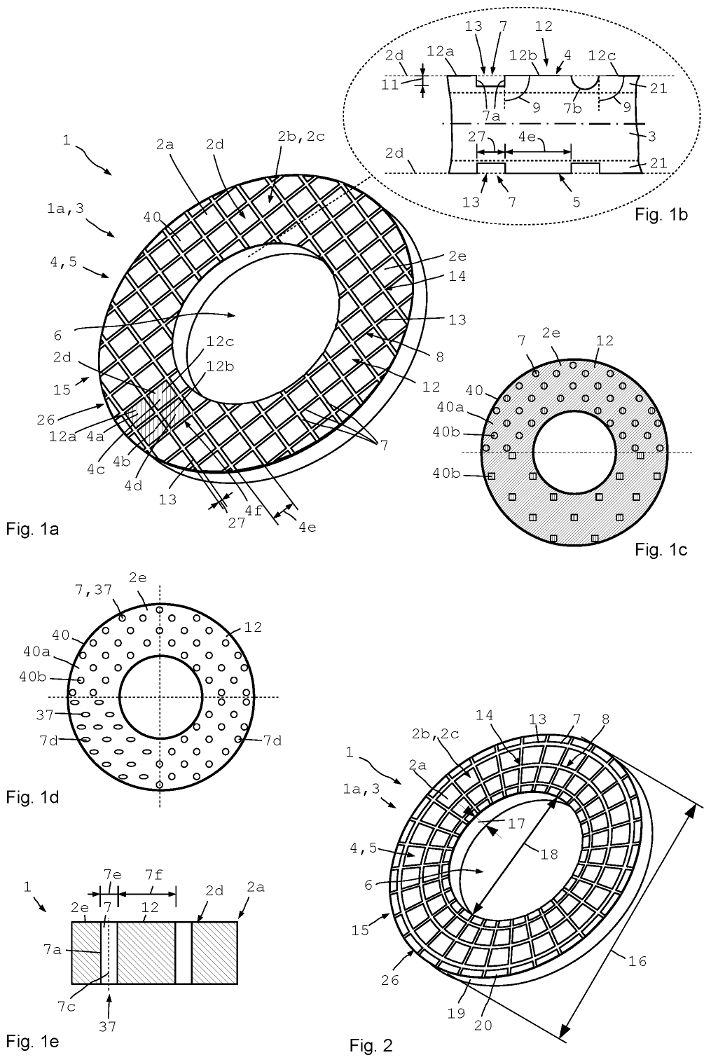

FIG. 1a shows a schematic, perspective view of an exemplary embodiment of a securing component 1a configured as a washer 3, of a securing device 1 according to the invention. The washer 3 comprises a contact body 2a with two outside surfaces 2b, 2c opposite one another. The washer 3 is configured mirror-symmetrical. The outside surfaces 2b, 2c form a first or top contact side 4 and a second, different, or bottom contact side 5. Both the contact sides 4, 5 are configured planar (and not curved, as in a spring washer). The washer 3 shows a through opening 6, configured as a circumferentially closed through hole 6. Both of the contact sides 4, 5 are configured with depressions 7, each showing an angular respectively sharp-edged boundary 8. The tolerance of the workpiece edges of the sharp-edged boundary 8 is circa±0.01 mm.

The side surface 2e, being the surface of the outside surface 2b, shows the contact level 2d broken by a plurality of depressions 7. The depressions 7 separate the surface into different contact regions 4a to 4d etc. Each of the contact regions 4a to 4d shows a (largely) planar contact surface 12a etc. All of these contact surfaces 12a, 12b and 12c (FIG. 1b), and thus the surfaces of the contact regions 4a, 4b and 4c are disposed respectively configured within a shared contact level 2d. The contact regions 4a to 4d (each being largely) configured planar (as well as the other contact regions not specifically indicated) on the whole define a contact level 2d, on which they are all disposed together and which show a shared planeness. The side surface of the entire securing device 1 is limited by the contact level 2e perpendicular to the surface. No part, nor any section of the securing device 1 protrudes beyond the surface of the contact regions 4a to 4d and thus the contact level 2d. Only the regions of the depressions 7 are recessed from the contact level 2d.

The depressions 7 are configured as elongated grooves 13. The elongated grooves 13 advantageously show a long, sharp-edged boundary 8. This means that an angular outline is present from the contact surface 12a into the groove 13, and again from the groove 13, an angular outline to the surface on the contact surface 12c. The boundary 8 does not protrude outwardly beyond the contact level 2d. In preferred configurations, the angle between faces 9 is approximately 90°, at least in the region of the surface.

The contact regions 4a to 4d may each be configured angular and e.g. approximately square, or they may show other shapes. The surface ratio 40a of the contact surfaces 12a, 12b etc. on the whole, to the entire side surface, may be estimated by way of the hatched area 4f. The surface of the hatched square can be computed from the width 4e squared of a contact region plus the width 27 of a groove 13. The surface ratio of the contact surface 12 inside of the hatched area results in four times the width 4e squared. The difference shows the surface ratio 40b of the depressions. Alternately, the surface ratio of the groove 13 in the hatched region may be determined to eight times the width 4e multiplied with the width 27 of the groove, plus four times the width 27 squared.

Here, the contact region 4a in the hatched region shows a width (and length) 4e, which is six times the width 27 of the grooves 13. The result is a total area of the hatched region of 14 times 14=196 unit surface areas. The proportion of the planar contact surface 12 thereof is 4 times 6 times 6=144 unit surface areas. The result is, a surface ratio 40a of the planar contact surface 12 of approximately 73.5%. Conversely, a total area of the depressions 7 in the hatched region is 8 times 1 times 6 plus 4 times 1 times 1, resulting in 52 unit surface areas and a surface ratio 40b of the depressions 7 of 26.5%. Thus, the surface ratio 40a of the planar contact surface 12 is above 70% and the surface ratio 40b, beneath 30%. This enables a secure, permanent screwed connection, including with high thermal loads, and with vibratory stresses.

The elongated grooves 7 are configured straight and extend over the entire diameter 16 of the contact sides 4, 5 of the contact body 2a of the washer 3. The grooves 13 extend at angles to one another over the contact sides 4, 5. The elongated grooves 13 intersect. A plurality of intersections 14 is present. In the intersections 14, two grooves 13 cross at an intersection angle of 90°.

The width of the grooves 27 is constant and in this embodiment it is approximately 0.3 millimeters. The areas between the depressions 7 configured as grooves 13 together form the planar contact surface 12. The sharp-edged boundary 8 does not protrude beyond the contact surface 12. The proportion of the contact surface 12 to the pertaining contact side 4, 5 is noticeably more than 50%, so that other than the form-fit connection, a force-fit connection is established in tightening.

When establishing a screwed connection 2, counter layers 23, 24, configured for example as screw part 23 or component 24, may settle in the depressions 7 on the planar contact sides 4, 5. A form-closed connection is generated. The counter layers 23, 24 may be supported on the sharp-edged boundaries 8. At the same time, the large, planar contact surface 12 establishes a force-fit connection.

In the embodiment of FIG. 1a the securing component 1a is a washer 26. The securing component 1a of the securing device 1, configured as a washer 3, is configured as a standard washer 26. The standard washer 26 has dimensions 16, 17, 18 according to DIN 125.

The depressions 7 in the washer 3 were manufactured by (exactly) one embossing step on both sides. The embossing step includes, pressing an embossing punch with the specific profile into the washer 3 using a high force. This allows achieving high geometrical accuracy of the sharp-edged profile 8, which is decisive for the excellent securing properties of the securing device 1.

FIG. 1b also shows a schematic cross-section along the broken line, showing conceivable and preferred cross-sections of the depressions 7. The angles between faces 9 are preferably (nearly) perpendicular. The bottom 7b of the depression may be configured (nearly) angular, or it may be configured round or rounded. Basically, the bottom shape is not decisive. What is more significant is the orientation of the fixing edge and an angular or sharp-edged transition to the contact surface 12. The depth 11 of the fixing edge 10 or the depression is selected such that an (elastic and optionally slightly plastic) form-fit connection with the counter layer results.

FIG. 1c also shows a modification wherein the surface ratio 40a (hatched obliquely) of the planar contact surface 12 to the entire side surface 2e (hatched obliquely and vertically) is larger still and in both the modifications (above and beneath the broken symmetry line) it is 90% and more. The depressions 7 may e.g. show a circular cross section and be distributed over the surface. The surface ratio 40b (hatched vertically) of the depressions 7 is small, and in the example shown in FIG. 1c, approximately 10%.

Basically, it is also possible for the elements 7 not to be configured as depressions but, in another configuration, to protrude from the planar surface as elevations, e.g., perpendicular, forming elevations 7. Again in this case, one shared, planar contact surface 12 is provided. Then, each of the elevations 7 penetrate into the counter layer, until the contact surface 12 is in lockout. In this case, there is again provided a secure screwed connection where temperature or thermal effects do not give cause to fear great stress relief due to settling or creeping, if the contact surface 12 is directly blocked. The large planar contact surface provides high effectiveness. The other dimensions and configurations and angles apply in analogy to the elevations as they do to the depressions.

It is also possible for individual or all of the depressions 7 to be configured as through holes.

FIG. 1d shows a variant in which basically, all the dimensions are identical to the configuration according to FIG. 1a. The difference is that some, and in particular all, of the depressions 7 are configured as through holes 37. The through holes extend completely through the contact body 2a of the securing component 1a of the securing device 1 as shown in the cross-sectional view of FIG. 1e. The through holes 37 are aligned transverse, presently perpendicular, to the contact level 2d provided by the surface respectively side surface 2e. The side surface 2e respectively the two side surfaces 2e define a shared contact level 2d, beyond which no part or portion of the contact body 2a protrudes.

The individual through holes 37 may basically show any arbitrary cross section 7d. Preferably, the through holes 37 are aligned transverse and in particular perpendicular to the side surface 2e respectively the contact level 2d. The through holes 37 each show an axis line, which in particular forms an axis of symmetry 7c of the through holes 37. The through holes 37 are preferably configured symmetrical relative to the axis of symmetry 7c and in particular mirror-symmetrical and preferably rotationally symmetrical. The cross section may be configured round, as is illustrated in the top half of FIG. 1d. The cross section 7d may be provided oval or angular, or angular with rounded corners, as also shown in FIG. 1d.

Particularly preferably, the through holes 37 are manufactured with a Laser by one or multiple or many (short) impulses.

The material for the securing device 1 overall and in particular at least part of the contact body 2a may be a ceramic material. It is preferred that the contact body 2a consists at least predominantly of (at least) one ceramic material. In an advantageous embodiment, the contact body 2a is (predominantly or) entirely manufactured of the material zirconium oxide ceramic.

A through hole 37 preferably shows a maximum diameter 7e (see FIG. 1e) of less than 1 mm. Larger contact bodies show a diameter 7e of less than 1/30 of the outer diameter of the contact body. Preferably, the distance 7f between two adjacent through holes 37 is at least twice the maximum diameter 7e of a through hole 37.

In other respects, the exemplary embodiment according to FIG. 1d may be manufactured employing the dimensions and materials as for the other exemplary embodiments.

FIG. 2 shows a schematic, perspective view of another exemplary embodiment of a washer 3 configured as a securing component 1a having a contact body 2a with a through opening 6, of a securing device 1 according to the invention. The contact body 2a of the washer 3 shows two opposite outside surfaces 2b, 2c. The outside surfaces 2b, 2c are configured as two planar contact sides 4, 5, each showing a shared planeness on a contact level 2d. The planar contact surface 12 is broken by depressions 7. The through opening 6 is again configured as a through hole 6. The depressions 7 are again configured as grooves 13. The grooves 13 are again configured elongated. Some of the grooves 13 extend from the inside radially outwardly. Moreover, three annular, circumferential grooves 13 are provided. The radially extending grooves 13 and the annular grooves 13 intersect, each at an intersection angle of circa 90°. The grooves 13 form a netlike structure 15, which extends completely across the contact sides 4, 5. The washer 3 is configured mirror, and largely rotationally, symmetrical.

The firm closure with the netlike structure 15 prevents relative motion of the counter layers 23, 24, such as a screwed part 23 or a component 24, of a tightened screwed connection 2 to the washer 3 of the securing device 1, which might result in loosening of the screwed connection 2. The same effect is generated by the netlike structure 15 of the washer 3 according to the first exemplary embodiment in FIG. 1a.

The securing component 1a of the securing device 1 configured as a washer 3 is configured as an M 12 standard washer 26 according to DIN 125. The diameter 16 of the washer 3 corresponds to circa 24 mm. The diameter 18 of the through opening 6 is circa 13 mm. The height 17 of the washer 3 is circa 2.5 mm. Again, the proportion of the contact surface 12 to the contact sides 4, 5 is more than 50% or even 60%, so as to ensure a force-fit and form-fit securing function of the securing device 1.

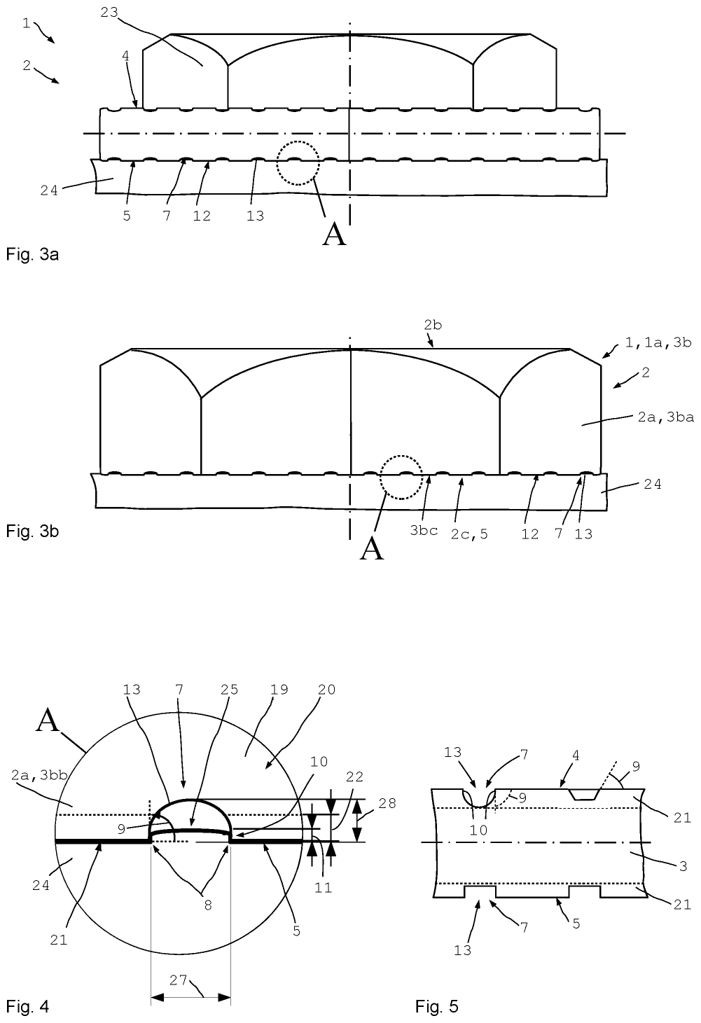

FIGS. 3a and 3b each show a schematic side view of a screwed connection 2 secured by means of the securing device 1 according to the invention, with one securing component 1a each. In the embodiment of FIG. 3a, the securing component 1a is configured as a mirror-symmetrical washer 3. The contact body 2a of the securing component 1a includes two opposite outside surfaces 2b, 2c. The two outside surfaces are configured as planar contact sides 4, 5, whose contact surfaces are configured on a shared (and common) contact level 2d. Two counter layers 23, 24, a screw part 23, and a component 24 are provided. The bottom contact side 5 of the washer 3 rests on the surface of the component 24 full surface. The screw part 23 rests on the top contact side 5. The screw part 23 is configured as a hexagon screw. The screw head of the hexagon screw of the screw part 23 rests on the top contact side 4. The component 24 and the screw part 23 have settled in the depressions 7 configured as grooves 13, so as to provide a form-fit connection.

In FIG. 3b, the securing component 1a is configured as a threaded screw 3b. The threaded screw 3b has a contact body 2a, which is configured as a screw head 3ba. Moreover, the threaded screw 3b has a threaded pin 3bb. The screw head 3ba has two outside surfaces 2b, 2c. The outside surface 2c is configured as a bottom contact surface 5. On the screw head 3ba, a bottom contact surface 5 is configured, including the depressions 7 with the sharp-edged boundary 8. The contact surface 5 is configured on a front face 3bc facing the threaded pin 3ba. The depressions 7 are configured as elongated grooves 13. The grooves 13 are distributed on the screw head 3ba over a substantial portion of the bottom contact side 5, again forming a netlike structure 15. The counter layer 24 is formed by the component 24, which settles in the grooves 13 during tightening.

FIG. 4 shows a schematic detail view of a depression 7, configured on a planar bottom contact surface 5, on a contact body 2a configured as a screw head 3ba as shown in the circled regions A of FIGS. 3a and 3b. Likewise, the depression 7 may be provided on a securing component 1a configured as a threaded screw 3b of a securing device 1 according to the invention. Here, a settled surface 25 of the component 24 is schematically shown. In tightening, the component 24 is deformed on the surface. Then, the material settles. During and after this, some of the material creeps into the depression 7. A form-fit connection is made between the component 24 and the washer 3, which is optionally elastic, so that the material slackens with loosening.

The settled surface 25 of the counter layer engages in the depression 7 configured as a groove 13. The component 24 is supported on the sharp-edged boundaries 8 of the depression 7. The sharp-edged boundary 8 does not protrude beyond the contact surface 12. The sharp-edged boundaries 8 are provided along the entire boundaries 8 of the depressions 7 configured as grooves 13. Here, an angle between faces 9 to the contact side of 90° is provided. It is thus ensured that tangentially acting forces are transmitted directly between the component 24 and the washer 3, without deflection as in the case of an oblique surface. Creeping allows the surface of the component 24 to settle even deeper in the depression 7. Then the settled surface 25 penetrates still deeper into the depression 7. Thus, creeping does not cause detrimental loss of the prestressing force of the screwed connection 2. High security is provided against loosening of the screwed connection 2.

The depression 13 configured as a groove 13 shows a fixing edge 10 at the boundary 8 in a linear configuration. The fixing edge 10 extends linearly at the gradient provided by the angle between faces 9, orthogonal to the surface of the component 24. The fixing edge 10 shows a depth 11 of circa 0.04 mm. The fixing edge 10 allows a force acting in the tangential direction to distribute over a large surface, to relieve the load on the boundary 8. The settled surface 25 does not protrude beyond the depth 11 of the fixing edge 10. Moreover, the groove 13 extends noticeably deeper than does the fixing edge 10. The depth of the groove 28 is circa 0.2 mm. The width of the groove 27 is in the range of 0.3 millimeters. The groove 13 is semicircular in cross section. Manufacturing is particularly conveniently done by reshaping by embossing.

The deformation of the counter layers 23, 24, which is minor throughout, ensures that the component 24 is not damaged or scratched. A varnish coat or a corrosion coating remain intact as a rule.

The form-fit connection (generated on the basis of the prestressing force) of the counter layers 23, 24 with the depressions 7 having the sharp-edged boundaries 8 in the securing component 1a, prevents loosening of the screwed connection 2. This ensures an excellent securing function. The form-fit connection with the securing component 1a causes a loosening moment, for loosening the tightened screwed connection 2, to be larger than a tightening moment in tightening.

The contact body 2a is manufactured of stainless steel 19. The outside surfaces 2b, 2c of the contact sides 4, 5 show a hardened surface 21 or they are through-hardened. The surface hardness is presently 250 HV, although it may be noticeably higher or lower, depending on the application. The hardening depth 22 is higher than the depth 11 of the fixing edge 11. Moreover, the contact body 2a may also comprise a corrosion coating 20.

FIG. 5 shows a schematic view of two different cross sections of depressions 7 of contact sides 4, 5 of a contact body 2a of a securing component 1a of a securing device 1 according to the invention. Other than a semicircular cross section of the groove 13 in the top portion, the bottom portion shows an alternative, rectangular cross section of the groove 13, which can for example be realized readily and cost-effectively by machining. The grooves 13 on a top contact side 4 and a bottom contact side 5 may be aligned at an offset to one another in all the configurations.

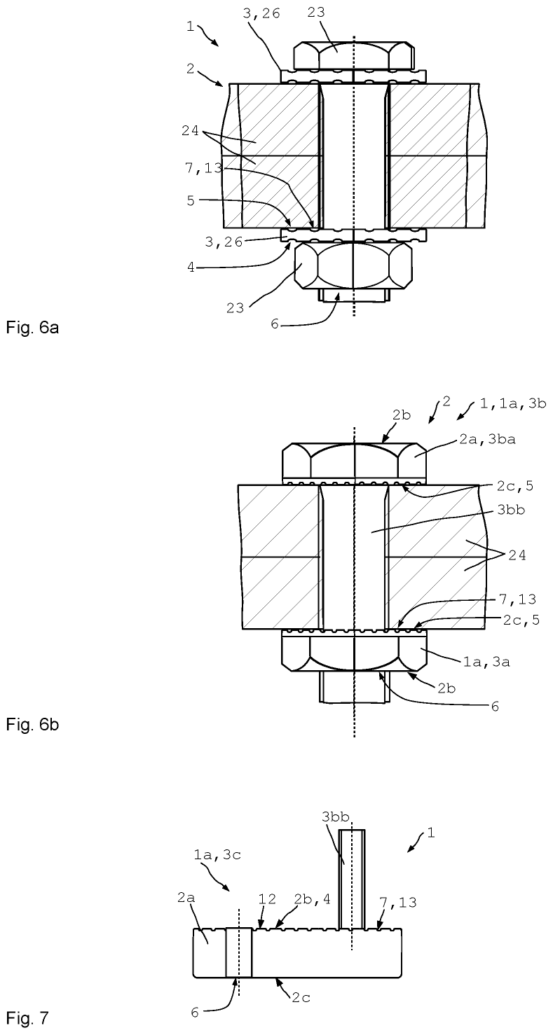

FIG. 6a shows a schematic sectional view of a screwed connection 2 secured with the securing device 1 according to the invention, wherein two securing components 1a are provided configured as washers 3. Moreover, two screw parts 23 and two components 24 are provided. The screw parts 23 are configured as a hexagon screw and a nut. The screw parts 23 and the components 24 show a surface hardness lower than that of the hardened surfaces 21 of the washer 3.

FIG. 6b shows another embodiment. The securing device 1 of FIG. 6b comprises two securing components 1a, a threaded screw 3b and a threaded nut 3a. The counter layers 24 are formed by the components 24. The threaded screw 3b shows a contact body 2a configured as a screw head 3ba. The screw head 3ba shows two outside surfaces 2b, 2c. One outside surface 2c is configured as a contact side 5. Moreover, the securing component 1a configured as a threaded screw 3b shows a threaded pin 3bb. Moreover, a securing component 1a configured as a threaded nut 3a is provided. The contact body 2a comprises two outside surfaces 2b, 2c, wherein one of the outside surfaces 2b, 2c is configured as the bottom contact side 5. The contact sides 5 are configured with depressions 7 having sharp-edged boundaries 8, extending across the entire contact side 5 as elongated grooves 13. The contact surface may be enlarged in the embodiment of FIG. 6b, as it is shown in FIG. 6a.

FIG. 7 shows an embodiment, where a securing component 1a configured as a securing unit 3c. The securing unit 3c comprises a contact body 2a comprising two opposite outside surfaces 2b, 2c. The outside surface 2b is configured as a top contact side 4, on which depressions 7 are configured having a sharp-edged boundary 8. The contact body 2a is provided with a through opening 6 connecting the two outside surfaces 2b, 2c, and a threaded pin 3bb protruding from the top contact side 4.

The invention provides a securing device 1 comprising at least one securing component 1a. The securing component 1a is configured as a washer 3, a threaded nut 3a, a threaded screw 3b, and/or a securing unit 3c. The securing component 1a comprises a contact body 2a having two outside surfaces 2b, 2c opposite one another. At least one of the outside surfaces 2b, 2c is configured as a planar contact side 4, 5. The contact body comprises at least one through opening 6 connecting the two outside surfaces 2b, 2c to pass through e.g. a threaded pin 3bb and/or at least one threaded pin 3bb protruding from the contact side 4, 5. At least one contact side 4, 5 is provided with a plurality of depressions 7 configured as grooves 13, comprising in particular a sharp-edged boundary 8 with an angle between faces 9 to the contact side of ca. 90° (±10°). The grooves 13 extend transverse across the contact sides 4, 5 and comprise intersections 14. This prevents tangential migrating of a counter layer 23, 24. In tightening, the counter layers 23, 24 settle in the depressions 7, so as to provide a form-fit connection. The settled surface 25 is supported on the fixing edges 10. Moreover, a planar contact surface 12 advantageously comprises a portion of at least 50% on the contact side 4, 5, so as to also provide a force-fit connection. Advantageously, an excellent securing function of a screwed connection 2 is thus enabled. The depressions 7 in the contact surfaces 12 can be manufactured particularly inexpensively by reshaping by means of exactly one embossing step. To manufacture a washer 3 according to the invention, a standard washer 26 can in particular be used.

Further advantages of the invention are described below.

There are in the market, in particular a plurality of lock washers such as wedge lock washers, LOCKTIX® disks, SCHNORR® disks, securing washers. All of these advantageously effect, using the prestressing force generated by tightening the screwed connection, that the disks cut into the counter layers (screw head, nut, workpiece), thus obtaining, preferably in addition to the traction, also a form closure, at least on one side of the disk, by way of the disks profiling due to cutting in. Pairs of wedge lock washers moreover advantageously operate with a wedge geometry on the insides, having a larger angle than does the pertaining gradient of the screw thread, thus additionally providing an unscrewing suppression.

Drawbacks of the solutions known thus far:
Most lock washers preferably have very small, sharp or pointed contact surfaces.
Thus they preferably press into, destroying the surfaces/varnish of, the counter layers (screws/nuts/workpieces).
The screwed connections 2 in particular continuously lose prestressing force by “creeping” over time, caused by static and dynamic and/or thermal loads, taking into account the prestressing force.
In particular the loosening moment is smaller than the tightening moment.
Preferably, they show different dimensions 16, 17, 18 than standard washers, so without examination, they cannot be simply exchanged.
Most of the good lock washers are in particular very expensive (such as wedge lock washers and LOCKTIX® disks).

Many of the currently used, functionally good lock washers only show an overall very small local supporting surface in the planar. As a rule, their profiling shows pointed/sharp wedges and cutting edges toward the contact surface, which achieve a cutting effect. Thus, even after mounting, they continue to cut deeper into the counter layers, which they can permanently deform and considerably damage, caused by the pertaining loads in application, in conjunction with high prestressing forces. Thus, the known securing devices 1 can continuously lose their prestressing force. They tend to penetrate the varnish, and to destroy corrosion protection.

The pure contact surfaces (actual contact surfaces) are very small due to the cone- or pyramid-shaped points or wedges (e.g. LOCKTIX® disks) or due to the sharp edges (wedge lock washers, SCHNORR® disks). In total, the supporting surfaces tend to be less than 20% of the total area provided. Thus, a locally acting force on the contact surfaces is accordingly high and the counter layers on screws, nuts, and workpieces tend to yield, allowing the lock washers penetration, which in particular shows negative effects on their prestressing force.

Moreover, many existing lock washers only show a radial embossed pattern which may only partially narrow the freedom of movement of the connection pieces in the planar.

Lock washers known in the prior art such as wedge lock washers and LOCKTIX® disks are very expensive, so that they tend to be used locally only. Moreover, securing washers (medium price range) are proven to show reduced securing properties according to Junker test.

Moreover, nearly all the popular lock washers preferably show different dimensions than standard washers. Therefore, exchanging is not always readily possible since the screw length or the space available do not permit exchanging.

The invention is in particular based on the object to permanently prevent unaided loosening of screwed connections. Moreover, a prestressing force applied during mounting is preferably intended to be retained the best possible. Preferably, the components (screws/nuts/workpieces) should not damage each other.

In particular the lock washers, preferably in all conceivable sizes, should be made of a material harder than the material of which the counter layers (screw/nut/workpiece) consist. For reasons of cost, in particular various hardness variants may be manufactured for the pertaining strength classes. Moreover, the lock washers should advantageously show the largest possible, planar contact surface.

Preferably, the lock washers are provided with effective form-fit recesses on both sides. The specific depressions (the profile pattern per se, whether cross-serrated, netting cubes, triangles or polygons, is secondary) are advantageously inserted at right angles (ca. 90°) and preferably sharp-edged (tolerance less than ±0.1 mm or less than ±0.05) to the planar contact surfaces.

These depressions (grooves or notches) in particular provide the counter layers (screws/nuts/workpieces) with the option, preferably taking into account the prestressing force, to “settle” in them in particular already during mounting, and subsequently to minimally “creep/flow” in further. This advantageously causes additional compacting to the surface of the counter layers, so that deeper penetration in particular gets ever harder.

The 90° edges of the profile which are in particular sharp but burr-free, form minimal edges, preferably during mounting by the components settling, so that, taking into account the applied prestressing force, further twisting or slipping is prohibited on all the axes, so that the components can be advantageously fixed to one another.

The corrosion protection applied is preferably various coatings such as zinc, zinc lamella, nickel or the like.

Advantages of the invention are in particular:
They secure in particular permanently, screwed connections against (unaided) detaching and loosening.
They fix in particular each of the components of the screwed connection to one another.
They retain, advantageously permanently, the prestressing force on a very high level.
They effect form closure, which in particular increases the tightened screwed connection by “creeping” with higher loads and over time.
They advantageously retain the corrosion protection (varnish, zinc coating, etc.) of the counter layers, since the screw head (smaller friction surface) advantageously slips through across the contact body during mounting.
By their specific depressions (form closure depressions) they block in particular, taking into account the prestressing force and the settling thus generated, the freedom of movement of the counter layers on all the axes.
They are advantageously exchangeable against current standard disks due to their dimensions.
They are in particular embossed identically on both sides.
they can preferably be manufactured at lower cost than comparable securing members.
The loosening moment is as a rule preferably higher than the tightening moment, due to the settling and creeping behavior.

### Exemplary Embodiments of the Invention

The embodiment, which is in particular configured as a washer 3, preferably in particular should be structured so that, after settling the washer, the freedom of movement, taking into account the prestressing force, is in particular blocked in all the axes.

The proportion of the advantageously planar contact surface must be, following the embossing step, in particular at least 50% or larger than the unprofiled, original basic surface, to permanently limit the settling and creeping behavior.

Protection is Sought in Particular for:

A securing device 1, which advantageously comprises depressions 7, inserted into the planar contact surfaces 12, sharp-edged (±0.1 mm) and in particular at right angles to the contact surfaces 12, in particular with fixing edges, which are preferably inserted into the planar and parallel contact surfaces 12.

A securing device 1, wherein in particular the depressions 7 are advantageously inserted into the contact surfaces 12 evenly/netlike and preferably on both sides.

A securing device 1, wherein in particular the depressions 7 are inserted, preferably in the contact surfaces 12, in particular evenly/netlike, if preferred not completely on both sides, preferably one surface entirely and the opposite surface at least in the inner region of the screw support.

A securing device 1, wherein in particular the remaining planar contact surface 12, advantageously retains at least 50% of the original surface, on the contact side 4, 5, preferably after inserting the depressions 7 with the sharp-edged boundary 8.

A securing device 1, wherein the washer 3 in particular consists of a material having a surface hardness 20 of 50 or 200 HV or more. The surface hardness 20 of the washers is advantageously intended to always be higher than the counter layers 23, 24 (screws/workpieces) of the connection.

### REFERENCE NUMBER TABLE

| | |
|---|---|
| 1 | securing device |
| 1a | securing component |
| 2 | screwed connection |
| 2a | contact body |
| 2b | outside surface of 2a |
| 2c | outside surface of 2a |
| 2d | contact level |
| 2e | side face |
| 3 | washer |
| 3a | threaded nut |
| 3b | threaded screw |
| 3ba | screw head of 3b |
| 3bb | threaded pin of 3b |
| 3bc | front face of 3ba |
| 3c | securing unit |
| 4 | (top) contact side |
| 4a | contact region |
| 4b | contact region |
| 4c | contact region |
| 4d | contact region |
| 4e | width of 4a, 4b, 4c, 4d |
| 4f | hashed area |
| 5 | (bottom) contact side |
| 6 | through opening of 3 |
| 7 | depression |
| 7a | wall of 7 |
| 7b | bottom of 7 |
| 7c | axis of symmetry |
| 7d | cross section |
| 7e | maximum diameter |
| 7f | distance |
| 8 | sharp-edged boundary |
| 9 | angle between faces |
| 10 | fixing edge |
| 11 | depth of 10 |
| 12 | contact surface |
| 12a | contact surface |
| 12b | contact surface |
| 12c | contact surface |
| 13 | groove |
| 14 | intersection |
| 15 | netlike structure |
| 16 | diameter of 3 |
| 17 | height of 3 |
| 18 | diameter of 6, hole diameter |
| 19 | stainless steel |
| 20 | corrosion protection |
| 21 | hardened surface |
| 22 | depth of 21 |
| 23 | screw part, counter layer |
| 24 | component, counter layer |
| 25 | settled counter layer (23, 24) |
| 26 | standard washer |
| 27 | width of 13 |
| 28 | depth of 13 |
| 37 | through hole |
| 40 | side face |
| 40a | surface ratio of 12 |
| 40b | surface ratio of 7 |

What is claimed is:

1. Securing device for establishing a secured screwed connection, comprising:
at least one securing component in the form of a washer, wherein the securing component comprises a contact body with two opposite outside surfaces, at least one of which is configured as a contact side for contacting a counter layer and comprising a side surface on the contact side,
wherein the securing component comprises at least one through opening connecting the two outside surfaces to pass through a threaded pin,
wherein on the contact side of the contact body, a planar contact surface is configured that is broken by a plurality of sharp-edged depressions and defines a contact level, limiting the contact body in the region of the side surface, so that the contact body does not protrude beyond the contact level in the region of the side surface,
wherein the surface ratio of the planar contact surface disposed on the contact level to the side surface is larger than the surface ratio of the sharp-edged depressions to the side surface.

2. The securing device according to claim 1, wherein the surface ratio of the contact surface to the side surface is larger than 60%.

3. The securing device according to claim 1, wherein a plurality of separate and individual, sharp-edged depressions are configured on the contact surface.

4. The securing device according to claim 1, wherein a plurality of contact regions, each with planar contact surfaces and sharp-edged depressions disposed in-between, is configured on the contact side of the contact body, and that the contact surfaces of the contact regions open up the contact level.

5. The securing device according to claim 4, wherein the contact surfaces of the contact regions comply with one shared planeness according to DIN EN ISO 1101:2017-0.

6. The securing device according to claim 1, wherein a transition from the planar contact surface to a wall of a depression is configured sharp-edged according to DIN EN 13715-2020-01.

7. The securing device according to claim 1, wherein the angle between faces of the sharp-edged depression to the planar contact region is between 75° and 105°.

8. The securing device according to claim 6, wherein the contact body and the sharp-edged boundary do not protrude beyond the planar contact surface.

9. The securing device according to claim 1, wherein the sharp-edged depressions are configured as grooves, which are disposed distributed over the contact side of the contact body, and wherein at least some of the grooves intersect and wherein the sharp-edged depressions form a netlike structure.

10. The securing device according to claim 1, wherein the contact body is configured mirror-symmetrical and rotationally symmetrical.

11. The securing device according to claim 1, wherein the contact side has a larger surface hardness than does a counter layer.

12. The securing device according to claim 1, wherein a plurality of sharp-edged depressions are configured as through holes.

13. The securing device according to claim 12, wherein the axis of symmetry of the through hole extends transverse to a side surface.

14. The securing device according to claim 13, wherein the through hole has a cross section which is selected from the group of cross sections consisting of round, oval, and rounded cross sections.

15. The securing device according to claim 12, wherein a through hole has a maximum diameter of less than 1 mm.

16. The securing device according to claim 12, wherein a distance between two adjacent through holes is at least twice the maximum diameter of a through hole.

17. The securing device according to claim 1, wherein the contact body consists at least predominantly of a ceramic material.

18. The securing device according to claim 17, wherein the contact body comprises the material zirconium oxide ceramics.

19. The securing device according to claim 1, further comprising an object on which a counter layer is configured, wherein the contact body rests with its contact side against the counter layer and is urged against the counter layer of the object by screwing means.

20. Securing device for establishing a secured screwed connection, comprising:
at least one securing component, wherein the securing component is selected from the group consisting of a threaded nut, a threaded screw, and a securing unit,
wherein the securing component comprises a contact body with two opposite outside surfaces, at least one of which is configured as a contact side for contacting a counter layer and comprising a side surface on the contact side,
wherein the securing component comprises at least one through opening connecting the two outside surfaces to pass through a threaded pin and/or at least one threaded pin protruding from the contact side of the securing component,
wherein on the contact side of the contact body, a planar contact surface is configured that is broken by a plurality of sharp-edged depressions and defines a contact level, limiting the contact body in the region of the side surface, so that the contact body does not protrude beyond the planar contact surface in the region of the side surface, wherein the surface ratio of the contact surface disposed on the contact level to the side surface is larger than the surface ratio of the sharp-edged depressions to the side surface.
